(19) United States
(12) Patent Application Publication
(10) Pub. No.: US 2015/0237136 A1
(43) Pub. Date: Aug. 20, 2015

(54) Information Display System, Information Display Method, Server, Control Method for Server, and Program

(71) Applicant: BIGLOBE Inc., Tokyo (JP)

(72) Inventor: Nobuyuki Enomoto, Tokyo (JP)

(73) Assignee: BIGLOBE Inc., Tokyo (JP)

(21) Appl. No.: 14/429,601

(22) PCT Filed: May 14, 2013
(86) PCT No.: PCT/JP2013/063361

§ 371 Date: Mar. 19, 2015

(30) Foreign Application Priority Data
Sep. 26, 2012 (JP) 2012-212476

(51) Int. Cl. H04L 29/08; H04L 29/06

(52) U.S. Cl. CPC H04L 67/1097; H04L 67/42; H04L 67/36

(57) ABSTRACT

An information display system of the present invention includes: an information processing device capable of reading an identifier of a tag; and a server capable of performing communication with the information processing device through a network. The server: stores an identifier of a first tag and an identifier of a second tag corresponding to the first tag in a manner of being related to each other; stores information in a manner of being related to each of the identifier of the first tag and the identifier of the second tag; when the identifier of the first tag or the identifier of the second tag and an acquisition request for the information corresponding thereto are received from the information processing device, transmits to the information processing device the information stored in a manner of being related to the received identifier and, when the identifier of one tag selected from the identifier of the first tag and the identifier of the second tag as well as a setting request for the information corresponding to the other tag are received from the information processing device, stores the information requested in the setting request, in a manner of being related to the identifier of the other tag. The information processing device displays the information transmitted from the server.

### TECHNICAL FIELD

The present invention relates to an information display system, an information display method, a server, a control method for server, and a program utilizing a tag.

### BACKGROUND ART

Techniques concerning tags capable of transmission and reception of information by short distance wireless communication (NFC: Near Field Communication) have been investigated. Techniques of application of such tags include the following.

Patent Document 1 (Japanese Patent Laid-Open Publication No. 2007-33310) discloses a technique that in a site such as an amusement park, occurrence of a missing child is detected by utilizing a pair of tags. According to this technique, tag IDs of a pair of tags are stored in a manner of being related to each other. Then, one of the pair of tags carried by a parent and the other is carried by a child. After a tag reader provided in a site has read one tag, when the other tag is not read within a predetermined time, occurrence of a missing child is concluded and hence a warning is issued to a portable device registered in advance like a portable device owned by the parent.

Further, Non-patent Document 1 discloses a technique that information such as an address, a name, and a telephone number is written in a tag. According to this technique, when an information processing device capable of reading a tag reads the tag, the information processing device can acquire the information stored in the tag.

Further, Non-patent Document 2 discloses a technique that information corresponding to a tag is stored on a network and then a URI (Uniform Resource Identifier) serving as a resource identifier indicating a resource that stores the information on the network is written in the tag. According to this technique, when an information processing device capable of reading a tag reads a URI stored in the tag and then accesses an on-the-network resource indicated in the URI, the information processing device can acquire the information corresponding to the tag.

### PRIOR ART REFERENCE

### Patent Document

Patent Document 1: Japanese Patent Laid-Open Publication No. 2007-33310

### Non-Patent Documents

### Non-Patent Document 1:

NFC Forum Type Tags White Paper V1.0, NXP Semiconductors, Apr. 1, 2009, P. 15, 4.3 vCard Use Case [retrieved on Sep. 7, 2012 (Heisei 24)] Internet <http://www.nfc-forum.org/resources/white_papers/NXP_BV_Type_Tags_White_Paper-Apr_{—}09.pdf>

### Non-Patent Document 2:

Smart Poster Record Type Definition Technical Specification, NFC Forum, SPR 1.1, Jul. 24, 2006.

### SUMMARY OF INVENTION

### Problems to be Solved by the Invention

In the technique disclosed in Patent Document 1, only when a fixed read condition concerning the pair of tags is satisfied, a warning is issued to a particular portable device. Thus, the warning is issued only to the portable device set forth in advance and hence there is a possibility that the warning effect is insufficient.

In the techniques disclosed in Non-patent Documents 1 and 2, the read-out contents or the information stored in the on-the-network resource indicated in the read-out URI is displayed. Then, when warning contents are incorporated into the displayed contents, a warning can be issued to a plurality of devices and hence the warning effect can be made sufficient.

In this case, information acquired in accordance with reading of the tag need be changed suitably. In the technique disclosed in Non-patent Document 1, direct writing of information into the tag is necessary and hence the information stored in the tag cannot be changed by remote operation. Thus, in the technique disclosed in Non-patent Document 1, the information acquired in accordance with reading of the tag cannot be changed flexibly.

Further, in the technique disclosed in Non-patent Document 2, when a system is provided that can change the information stored in the on-the-network resource indicated in the URI stored in the tag, the information acquired in accordance with reading of the tag can be changed. Usually, in such a system, in order to avoid a situation that information is changed without permission by an unauthorized person, an ID and a password are assigned to an authorized person who has the authority of change. The authorized person need administer the ID and the password such as not to forget them or not to leak them to other persons. This requires time and effort.

An object of the present invention is to provide an information display system, an information display method, a server, a control method for server, and a program in which information corresponding to a tag can be changed more flexibly and simply.

### Means for Solving to the Problems

In order to achieve the above-mentioned object, the information display system of the present invention includes:

an information processing device capable of reading an identifier of a tag; and a server capable of performing communication with the information processing device through a network, wherein

the server includes:

a first storage section for storing an identifier of a first tag and an identifier of a second tag corresponding to the first tag, in a manner of being related to each other;

a second storage section for storing information in a manner of being related to each of the identifier of the first tag and the identifier of the second tag; and

a processing section for, when the identifier of the first tag or the identifier of the second tag and an acquisition request for the information corresponding thereto are received from the information processing device, transmitting, to the information processing device, the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request into the second storage section in a manner of being related to the identifier of the other tag, and wherein

the information processing device includes a display section for, when the information has been transmitted from the processing section, displaying contents of the information.

In order to achieve the above-mentioned object, the information display method in the information display system of the present invention is

an information display method in an information display system including: an information processing device capable of reading an identifier of a tag; and a server capable of performing communication with the information processing device through a network, wherein

the server:

stores an identifier of a first tag and an identifier of a second tag corresponding to the first tag in a manner of being related to each other;

stores information in a manner of being related to each of the identifier of the first tag and the identifier of the second tag; and

when the identifier of the first tag or the identifier of the second tag and an acquisition request for the information corresponding thereto are received from the information processing device, transmits to the information processing device the information stored in a manner of being related to the received identifier and, when the identifier of one tag selected from the identifier of the first tag and the identifier of the second tag as well as a setting request for the information corresponding to the other tag are received from the information processing device, stores the information requested in the setting request, in a manner of being related to the identifier of the other tag, and wherein

when the information has been transmitted from the server, the information processing device displays contents of the information.

In order to achieve the above-mentioned object, the server of the present invention is

a server capable of performing communication, through a network, with an information processing device capable of reading an identifier of a tag, comprising:

a first storage section for storing an identifier of a first tag and an identifier of a second tag corresponding to the first tag, in a manner of being related to each other;

a second storage section for storing information in a manner of being related to each of the identifier of the first tag and the identifier of the second tag; and

a processing section for, when the identifier of the first tag or the identifier of the second tag and an acquisition request for the information corresponding thereto are received from the information processing device, transmitting, to the information processing device, the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request into the second storage section in a manner of being related to the identifier of the other tag.

In order to achieve the above-mentioned object, the control method of the server of the present invention is

a control method for a server capable of performing communication, through a network, with an information processing device capable of reading a tag, comprising:

storing an identifier of a first tag and an identifier of a second tag corresponding to the first tag in a manner of being related to each other;

storing information in a manner of being related to each of the identifier of the first tag and the identifier of the second tag; and

when the identifier of the first tag or the identifier of the second tag and an acquisition request for the information corresponding thereto are received from the information processing device, transmitting to the information processing device the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request, in a manner of being related to the identifier of the other tag.

In order to achieve the above-mentioned object, the program of the present invention causes

a computer to execute:

the processing of storing an identifier of a first tag and an identifier of a second tag corresponding to the first tag, in a manner of being related to each other;

the processing of storing information in a manner of being related to each of the identifier of the first tag and the identifier of the second tag; and

the processing of, when the identifier of the first tag or the identifier of the second tag and an acquisition request for the information corresponding thereto are received from an information processing device capable of reading a tag, transmitting to the information processing device the information stored in a manner of being related to the received identifier and, when the identifier of one tag selected from the identifier of the first tag and the identifier of the second tag as well as a setting request for the information corresponding to the other tag are received from the information processing device, storing the information requested in the setting request, in a manner of being related to the identifier of the other tag.

### Advantageous Effects of the Invention

According to the present invention, information corresponding to a tag can be changed more flexibly and simply.

### BRIEF DESCRIPTION OF THE DRAWINGS

FIG. 1 is a diagram showing a configuration of an information display system of a first embodiment of the present invention.

FIG. 2 is a diagram showing an example of a configuration of a tag DB shown in FIG. 1.

FIG. 3 is a diagram showing an example of a configuration of a pet DB shown in FIG. 1.

FIG. 4 is a diagram showing an example of a configuration of a message DB shown in FIG. 1.

FIG. 5 is a flow chart showing operation of a processing section 55 shown in FIG. 1 performed at the time of receiving of a display request.

FIG. 6 is a flow chart showing operation of a processing section 55 shown in FIG. 1 performed at the time of receiving of a setting request.

FIG. 7 is a sequence diagram showing operation of an information display system shown in FIG. 1.

FIG. 8 is a diagram showing an example of display of a display/input section 32 shown in FIG. 1.

FIG. 9 is a diagram showing an example of display of a display/input section 32 shown in FIG. 1.

FIG. 10 is a diagram showing an example of display of a display/input section 42 shown in FIG. 1.

FIG. 11 is a diagram showing an example of display of a display/input section 32 shown in FIG. 1.

FIG. 12 is a diagram showing an example of display of a display/input section 32 shown in FIG. 1.

FIG. 13 is a diagram showing an example of a configuration of a pet DB shown in FIG. 1.

FIG. 14 is a diagram showing an example of display of a display/input section 42 shown in FIG. 1.

FIG. 15 is a diagram showing an example of display of a display/input section 42 shown in FIG. 1.

FIG. 16 is a diagram showing an example of display of a display/input section 32 shown in FIG. 1.

FIG. 17 is a diagram showing a configuration of an information display system of a second embodiment of the present invention.

FIG. 18 is a flow chart showing operation of a processing section 55A shown in FIG. 17 performed at the time of receiving of a display request.

FIG. 19 is a flow chart showing operation of a processing section 55A shown in FIG. 17 performed at the time of receiving of a setting request.

### DESCRIPTION OF THE EMBODIMENTS

Embodiments for implementing the present invention are described below with reference to the drawings.

### First Embodiment

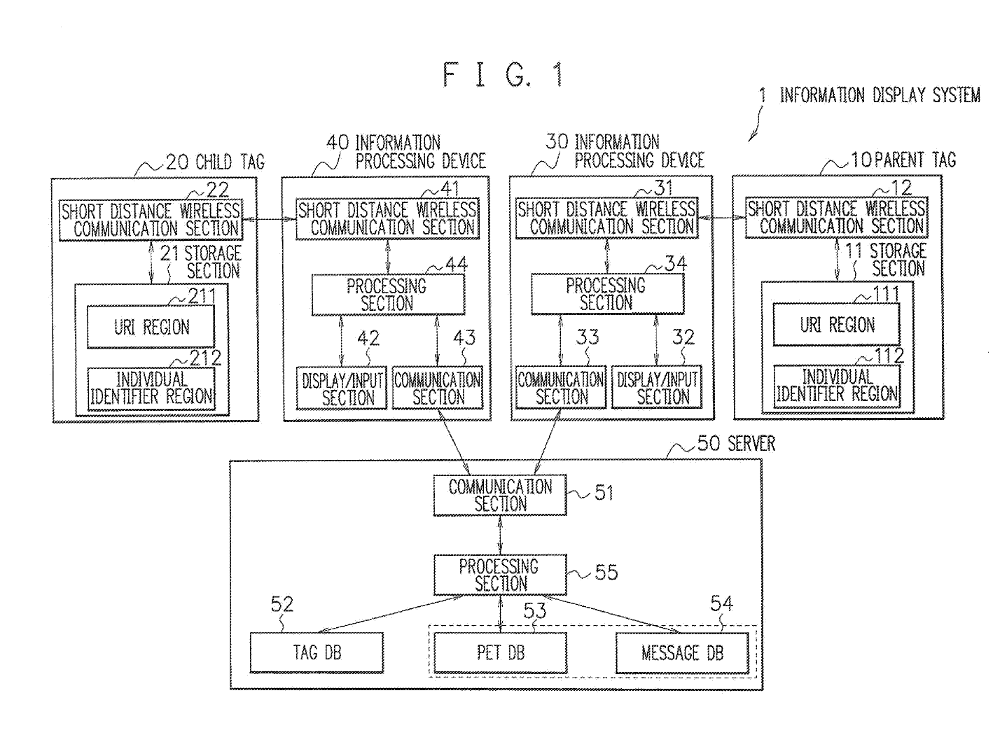

FIG. 1 is a diagram showing the configuration of an information display system of a first embodiment of the present invention.

The information display system 1 shown in FIG. 1 includes a parent tag 10, a child tag 20, information processing devices 30 and 40, and a server 50. The parent tag 10 is an example of the first tag and the child tag 20 is an example of the second tag.

Here, in the following description, the information display system 1 of the present embodiment is described for an example that the system is applied to a system in which a tag is attached to a pet and then the tag is read by an information processing device so that information and the like concerning the pet is displayed on the information processing device.

The parent tag 10 and the child tag 20 are tags capable of transmission and reception of information by short distance wireless communication (NFC). The child tag 20 is mounted on the collar or the like of the pet so as to be attached to the pet. The parent tag 10 is owned by a person, like the owner of the pet, who has the authority of administering the information allowed to be acquired by the information processing device in accordance with reading of the child tag 20. In the following description, it is premised that the parent tag 10 is owned by the owner of the pet.

Here, specific examples of the parent tag 10 and the child tag 20 include an NFC tag formatted in NDEF (NFC Data Exchange Format) Smart Poster format. Further, employable shapes of the parent tag 10 and the child tag 20 include a coin shape, a card shape, and a seal shape.

For example, the information processing devices 30 and 40 are smartphones (high functionality portable telephones), tablet terminals, or the like. In the following description, it is premised that the information processing device 30 is owned by the owner of the parent tag 10 and the information processing device 40 is owned by a person who is to read the child tag 20.

The server 50 stores information corresponding to the parent tag 10 and the child tag 20. Further, the server 50 can perform communication with the information processing devices 30 and 40 through a network and performs processing corresponding to requests from the information processing devices 30 and 40. Here, such requests from the information processing devices 30 and 40 include a display request of requesting acquisition of information corresponding to the tag (the type of the request: (GET)) and a setting request of requesting setting of information corresponding to the tag (the type of the request: (POST)).

Next, the configurations of the parent tag 10, the child tag 20, the information processing devices 30 and 40, and the server 50 are described below.

First, the configuration of the parent tag 10 is described below.

The parent tag 10 includes a storage section 11 and a short distance wireless communication section 12.

The storage section 11 is a nonvolatile memory such as a flash memory formatted in NDEF Smart Poster format. The storage section 11 includes a URI region 111 and an individual identifier region 112.

The URI region 111 is a region for storing a URI serving as a resource identifier indicating an on-the-network resource that stores the information corresponding to the parent tag 10.

The individual identifier region 112 is a region for storing an individual identifier uniquely indicating the parent tag 10. Specific examples of the individual identifier include an IDm and a uID. After an individual identifier has been stored into the individual identifier region 112, the individual identifier cannot be changed.

The short distance wireless communication section 12 performs transmission and reception of information to and from the information processing device by short distance wireless communication.

Next, the configuration of the child tag 20 is described below.

The child tag 20 includes a storage section 21 and a short distance wireless communication section 22.

The storage section 21 is a nonvolatile memory such as a flash memory formatted in NDEF Smart Poster format. The storage section 21 includes a URI region 211 and an individual identifier region 212.

The URI region 211 is a region for storing a URI indicating an on-the-network resource having stored the information corresponding to the child tag 20.

The individual identifier region 212 is a region for storing an individual identifier uniquely indicating the child tag 20. After an individual identifier has been stored into the individual identifier region 212, the individual identifier cannot be changed.

The short distance wireless communication section 22 performs transmission and reception of information to and from the information processing device by short distance wireless communication.

Next, the configuration of the information processing device 30 is described below.

The information processing device 30 includes a short distance wireless communication section 31, a display/input section 32, a communication section 33, and a processing section 34. The display/input section 32 is an example of the display section.

In accordance with the control of the processing section 34, the short distance wireless communication section 31 performs transmission and reception of information to and from the tag by short distance wireless communication.

In accordance with the control of the processing section 34, the display/input section 32 displays various kinds of information. Further, the display/input section 34 receives input from the user and then outputs to the processing section 34 a control signal corresponding to the inputted contents. Specific examples of the display/input section 32 include a touch panel. Here, the display/input section 32 may have a configuration that a display section such as an LCD (Liquid Crystal Display) and an input section such as key buttons are separated from each other.

In accordance with the control of the processing section 34, the communication section 33 performs communication with the server 50 through the network.

The processing section 34 controls the sections described above. For example, when operation input of holding the information processing device 30 above the tag so as to read the tag is performed, the processing section 34 receives a URI and an individual identifier from the tag by short distance wireless communication and then transmits through the communication section 33 to the server 50 the URI and the individual identifier having been received. Here, the transmission of the URI and the individual identifier to the server 50 is performed by a tag authentication application installed on the processing section 34. Further, comparison work between the individual identifier received through the short distance wireless communication section 31 and the individual identifier stored in a tag DB (Database) described later is performed in the inside of the server 50.

The information processing device 40 includes a short distance wireless communication section 41, a display/input section 42, a communication section 43, and a processing section 44. The short distance wireless communication section 41, the display/input section 42, the communication section 43, and the processing section 44 respectively correspond to the short distance wireless communication section 31, the display/input section 32, the communication section 33, and the processing section 34 in the information processing device 30. Thus, their description is omitted.

Here, in the present embodiment, it is premised that a tag authentication application is not installed in the processing section 44 and, instead, a browser application is installed for displaying information received from the server 50. The processing section 44 transmits through the communication section 43 to the server 50 the URI alone selected from the URI and the individual identifier received from the tag through the short distance wireless communication section 41.

Next, the configuration of the server 50 is described below.

The server 50 includes a communication section 51, a tag DB 52, a pet DB 53, a message DB 54, and a processing section 55. The tag DB 52 is an example of the first storage section. The pet DB 53 and the message DB 54 constitute the second storage section.

In accordance with the control of the processing section 55, the communication section 51 performs communication with the information processing devices 30 and 40 through the network.

The tag DB 52 is a database for storing the parent-child relationship and the like of the parent tag 10 and the child tag 20.

The pet DB 53 is a database for storing information concerning the pet that is set up by the owner of the parent tag 10 and that is to be disclosed to a person who has read the child tag 20.

The message DB 54 is a database for storing a message (referred to as a notification message, in some cases hereinafter) to be transmitted to the owner of the parent tag 10 that is in the parent-child relationship with the child tag 20 by a person who has read the child tag 20.

In accordance with a request from the information processing devices 30 and 40, the processing section 55 searches the tag DB 52, the pet DB 53, and the message DB 54 and then performs processing corresponding to the request. Here, in accordance with the type (GET/POST) of the request contained in the request from the information processing device, the processing section 55 judges whether the request is a display request or a setting request.

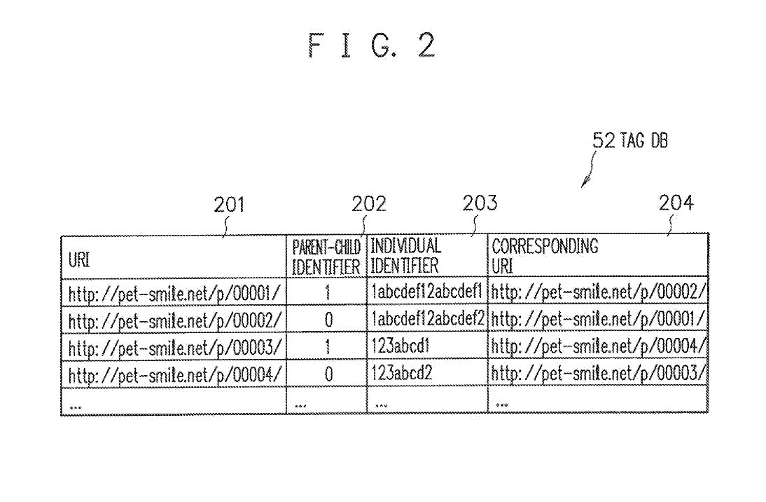

Next, the configuration of the tag DB 52 is described below with reference to FIG. 2. The tag DB 52 is constructed from a URI 201, a parent-child identifier 202, an individual identifier 203, and a corresponding URI 204.

The URI 201 is an entry serving as a search key for the tag DB 52.

The URI 201 is a region for storing a URI indicating an on-the-network resource having stored the information corresponding to the tag. In the present embodiment, a URI proper to each tag is set up (stored) and then this URI is used as an ID like a membership number. Here, the URI serving as a search key may be the URI of any one of the parent tag 10 and the child tag 20.

The parent-child identifier 202 is a region for storing a parent-child identifier indicating whether the tag in which the URI stored in the URI 201 has been set up is a parent tag or a child tag. In the present embodiment, it is premised that when the parent-child identifier is 1, the tag is a parent tag and, when the parent-child identifier is 0, the tag is a child tag.

The individual identifier 203 is a region for storing the individual identifier of a tag in which the URI stored in the URI 201 has been set up. Before the shipment of the tag, the URI and the individual identifier are encoded (set up) into the tag. Then, the URI and the individual identifier having been set up in the tag are read and stored into the tag DB 52. The URI and the individual identifier having been set up in the tag are stored in a manner of being related to each other. Then, when a request of access to the URI is issued, authentication is performed by using the individual identifier so that whether the access has been performed with reading an authorized tag can be checked.

The corresponding URI 204 is a region for storing a URI (referred to as a corresponding URI, hereinafter) set up in the tag that is in the parent-child relationship with the tag in which the URI stored in the URI 201 has been set up. When the URI stored in the URI 201 is one having been set as a parent tag, the URI having been set up in a child tag that is in the parent-child relationship with the parent tag is stored as the corresponding URI into the corresponding URI 204. Further, when the URI stored in the URI 201 is one having been set as a child tag, the URI having been set up in a parent tag that is in the parent-child relationship with the child tag is stored as the corresponding URI into the corresponding URI 204.

Storing of the URI, the parent-child identifier, the individual identifier, and the corresponding URI into the tag DB 52 is performed only at the time of factory shipment of the parent tag 10 and the child tag 20 which are in the parent-child relationship with each other and cannot be changed once storing has been completed.

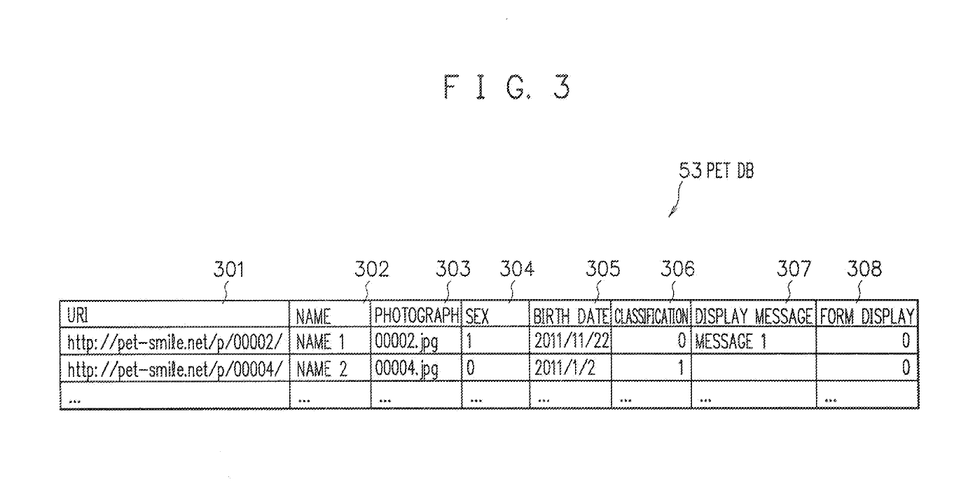

Next, the configuration of the pet DB 53 is described below with reference to FIG. 3.

The pet DB 53 is constructed from a URI 301, a name 302, a photograph 303, a sex 304, a birth date 305, a classification 306, a display message 307, and a form display 308.

The URI 301 is an entry serving as a search key for the pet DB 53.

The URI 301 is a region for storing the URI set up in the child tag 20.

The name 302 is a region for storing the name of the pet to which the child tag 20 in which the URI stored in the URI 301 has been set up is attached.

The photograph 303 is a region for storing the file name of a photograph of the pet to which the child tag 20 in which the URI stored in the URI 301 has been set up is attached.

The sex 304 is a region for storing an identifier indicating the sex of the pet to which the child tag 20 in which the URI stored in the URI 301 has been set up is attached. In the present embodiment, it is premised that when the identifier stored in the sex 304 is 1, the pet is male and, when the identifier stored in the sex 304 is 0, the pet is female.

The birth date 305 is a region for storing the birth date of the pet to which the child tag 20 in which the URI stored in the URI 301 has been set up is attached.

The classification 306 is a region for storing a classification indicating the sex of the pet to which the child tag 20 in which the URI stored in the URI 301 has been set up is attached. In the present embodiment, it is premised that when the identifier stored in the classification 306 is 0, the pet is a dog and, when the identifier stored in the classification 306 is 1, the pet is a cat. Further, it is premised that when the identifier stored in the classification 306 is 2, the pet is other than a dog and a cat.

The display message 307 is a region for storing a notification message to be transmitted to a person who has read the child tag 20 from the owner of the pet to which the child tag 20 in which the URI stored in the URI 301 has been set up is attached. The display message 307 stores a self-introduction text of the pet or the owner in a normal situation and, when the pet has become missing, stores a request for notification to the owner, the contact destination to the owner, and the like.

The form display 308 is a region for storing an identifier indicating whether a notification form used for inputting a notification message to be transmitted to the owner of the parent tag 10 that is in the parent-child relationship with the child tag 20 in which the URI stored in the URI 301 has been set up is to be displayed on the information processing device having read the child tag 20. In the present embodiment, it is premised that when the identifier stored in the form display 308 is 1, the notification form is to be displayed and, when the identifier stored in the form display 308 is 0, the notification form is not to be displayed. In a normal situation, 0 is set up in the form display 308 so that the notification form is not displayed. In contrast, when the pet has become missing, the form display 308 is changed from 0 into 1 so that the notification form is displayed on the information processing device having read the child tag 20. By virtue of this, a notification message can be transmitted from a person who has read the child tag 20 to the owner of the parent tag 10.

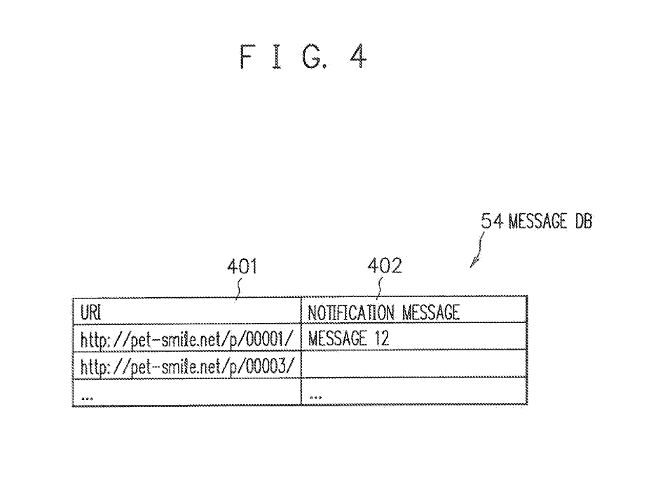

Next, the configuration of the message DB 54 is described below with reference to FIG. 4.

The message DB 54 is constructed from a URI 401 and a notification message 402.

The URI 401 is an entry serving as a search key for the message DB 54.

The URI 401 is a region for storing the URI set up in the parent tag 10.

The notification message 402 is a region for storing a notification message to be transmitted to the owner of the parent tag 10 from a person who has read the child tag 20 that is in the parent-child relationship with the parent tag 10 in which the URI stored in the URI 401 has been set up.

Next, operation of the information display system 1 of the present embodiment is described below.

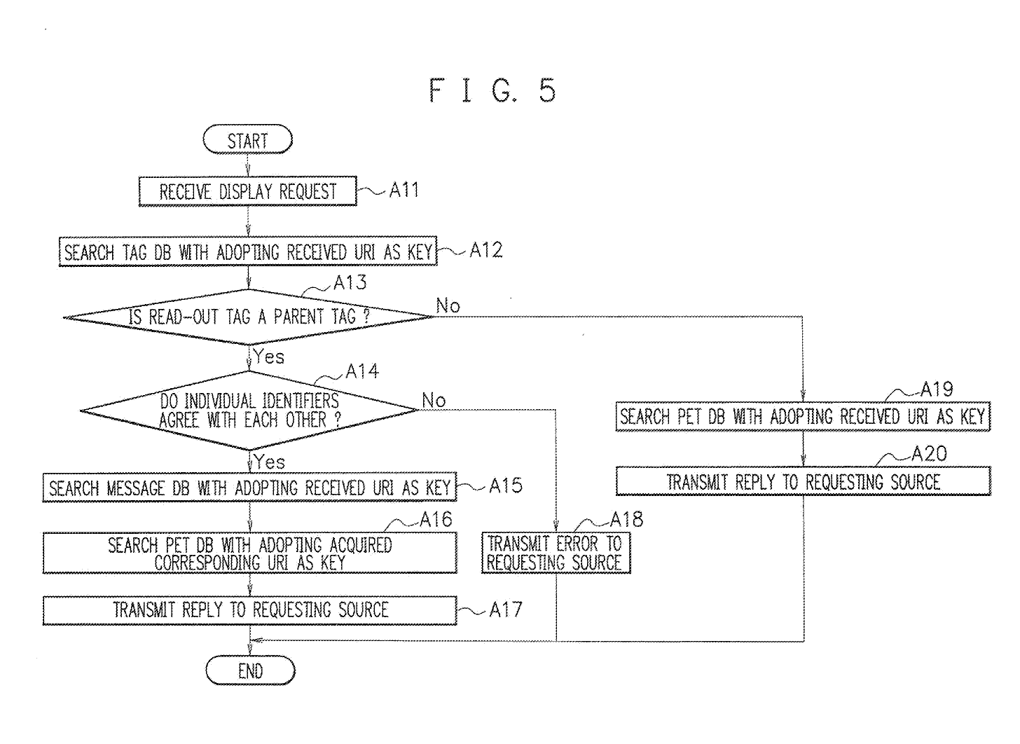

First, operation of the processing section 55 at the time of receiving of a display request is described below with reference to the flow chart shown in FIG. 5.

When a display request has been transmitted from the information processing device, the processing section 55 receives the display request through the communication section 51 (step A11). Here, when the transmission source of the display request is the information processing device 30, the display request contains a URI and an individual identifier. Then, when the transmission source of the display request is the information processing device 40, the display request contains a URI and does not contain an individual identifier. In the following description, the URI contained in the request received from the information processing device is referred to as a received URI and the individual identifier contained in the request received from the information processing device is referred to as a received individual identifier.

Then, the processing section 55 searches the tag DB 52 with adopting the received URI as a search key and thereby acquires from the tag DB 52 the parent-child identifier, the individual identifier, and the corresponding URI stored in a manner of being related to a URI equal to the received URI (step A12). In the following description, the individual identifier acquired from the tag DB 52 by the processing section 55 is referred to as an acquired individual identifier and the corresponding URI acquired from the tag DB 52 is referred to as an acquired corresponding URI.

Then, on the basis of the acquired parent-child identifier, the processing section 55 judges whether the tag in which the received URI has been set up, that is, the read-out tag, is a parent tag (step A13).

When the read-out tag is a parent tag (when the acquired parent-child identifier is 1) (step A13: Yes), the processing section 55 judges whether the received individual identifier and the acquired individual identifier agree with each other (step A14).

As described above, the display request transmitted from the information processing device 30 contains a URI and an individual identifier but the display request transmitted from the information processing device 40 contains a URI alone. Thus, for example, when the information processing device 40 has read the parent tag 10 and then transmitted a display request, the read-out tag is judged as a parent tag on the basis of the URI contained in the display request and then the processing of step A14 is performed. Here, the display request transmitted from the information processing device 40 does not contain an individual identifier. In this case, the processing section 55 judges that the received individual identifier and the acquired individual identifier do not agree with each other.

When the received individual identifier and the acquired individual identifier agree with each other (step A14: Yes), the processing section 55 searches the message DB 54 with adopting the received URI as a search key and thereby acquires a notification message stored in a manner of being related to a URI equal to the received URI (step A15).

Then, the processing section 55 searches the pet DB 53 with adopting the acquired corresponding URI as a search key and thereby acquires a name, a photograph, a sex, a birth date, a classification, a display message, and a form display stored in a manner of being related to a URI equal to the acquired corresponding URI (step A16).

Then, the processing section 55 transmits information indicating the notification message acquired at step A15 and indicating the name, the photograph, the sex, the birth date, the classification, the display message, and the form display acquired at step A16, through the communication section 51 to the information processing device of requesting source as a reply to the display request (step A17) and then terminates the processing.

When the received individual identifier and the acquired individual identifier do not agree with each other (step A14), the processing section 55 transmits an error through the communication section 51 to the information processing device of requesting source (step A18) and then terminates the processing.

When the read-out tag is not a parent tag (when the acquired parent-child identifier is 0) (step A13: No), the processing section 55 searches the pet DB 53 with adopting the received URI as a search key and thereby acquires a name, a photograph, a sex, a birth date, a classification, a display message, and a form display stored in a manner of being related to a URI equal to the received URI (step A19).

Then, the processing section 55 transmits information indicating the name, the photograph, the sex, the birth date, the classification, the display message, and the form display acquired at step A19, through the communication section 51 to the information processing device of requesting source as a reply to the display request (step A20) and then terminates the processing.

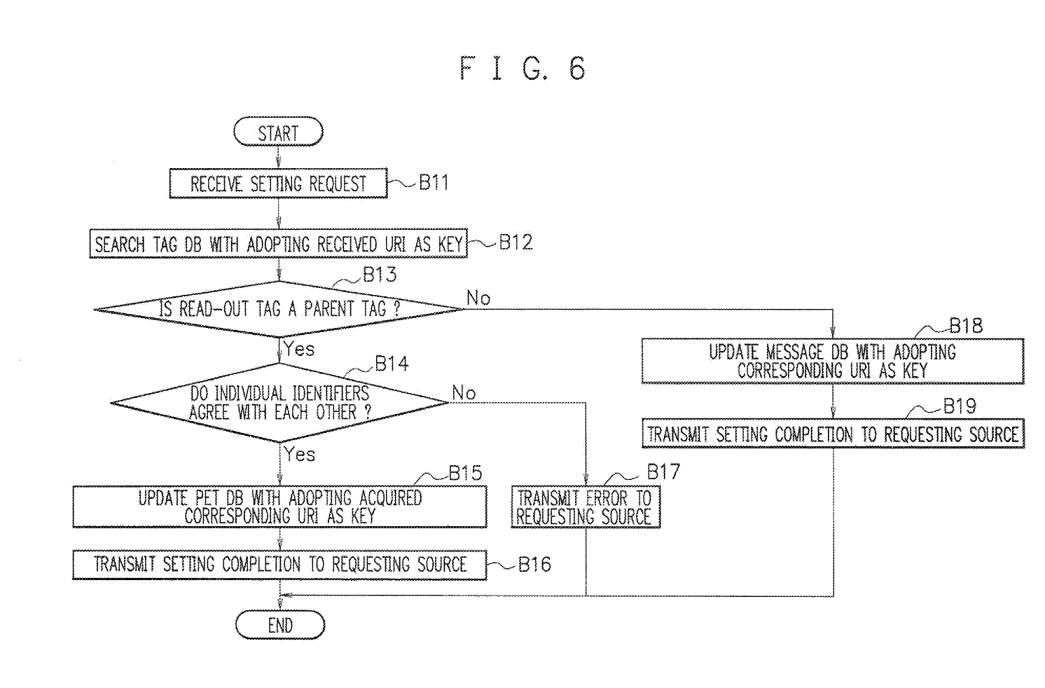

Next, operation of the processing section 55 at the time of receiving of a setting request is described below with reference to the flow chart shown in FIG. 6.

When a setting request has been transmitted from the information processing device, the processing section 55 receives the setting request through the communication section 51 (step B11). Here, when the transmission source of the setting request is the information processing device 30, the setting request contains a URI and an individual identifier. Then, when the transmission source of the setting request is the information processing device 40, the setting request contains a URI and does not contain an individual identifier.

Then, the processing section 55 searches the tag DB 52 with adopting the received URI as a search key and thereby acquires from the tag DB 52 the parent-child identifier, the individual identifier, and the corresponding URI stored in a manner of being related to a URI equal to the received URI (step B12).

Then, on the basis of the acquired parent-child identifier, the processing section 55 judges whether the tag in which the received URI has been set up, that is, the read-out tag, is a parent tag (step B13).

When the read-out tag is a parent tag (when the acquired parent-child identifier is 1) (step B13: Yes), the processing section 55 judges whether the received individual identifier and the acquired individual identifier agree with each other (step B14).

As described above, the setting request transmitted from the information processing device 30 contains a URI and an individual identifier but the setting request transmitted from the information processing device 40 contains a URI alone. Thus, for example, when the information processing device 40 has read the parent tag 10 and then transmitted a setting request, the read-out tag is judged as a parent tag on the basis of the URI contained in the setting request and then the processing of step B14 is performed. Here, the setting request transmitted from the information processing device 40 does not contain an individual identifier. In this case, the processing section 55 judges that the received individual identifier and the acquired individual identifier do not agree with each other.

When the received individual identifier and the acquired individual identifier agree with each other (step B14: Yes), the processing section 55 searches the pet DB 53 with adopting the acquired corresponding URI as a search key and thereby receives from the information processing device of requesting source a change concerning the name, the photograph, the sex, the birth date, the classification, the display message, and the form display stored in a manner of being related to a URI equal to the acquired corresponding URI. Further, the processing section 55 stores the changed contents into the pet DB 53 in a manner of being related to the retrieved URI so as to update the pet DB 53 (step B15), then transmits through the communication section 51 to the requesting source a situation indicating that setting has been completed (step B16), and then terminates the processing.

When the received individual identifier and the acquired individual identifier do not agree with each other (step B14: No), the processing section 55 transmits an error through the communication section 51 to the information processing device of requesting source (step B17) and then terminates the processing.

When the read-out tag is a child tag (when the acquired parent-child identifier is 0) (step B13: No), the processing section 55 searches the message DB 54 with adopting the acquired corresponding URI as a search key and then receives from the information processing device of requesting source a change of the notification message stored in a manner of being related to a URI equal to the acquired corresponding URI. Further, the processing section 55 stores the changed notification message into the message DB 54 in a manner of being related to the retrieved URI so as to update the message DB 54 (step B18), then transmits through the communication section 51 to the requesting source a situation indicating that setting has been completed (step B19), and then terminates the processing.

Operation of the information display system 1 of the present embodiment is described below more specifically.

Here, in the following description, the parent tag 10 is premised to store a URI “http://pet-smile.net/p/00001/” and an individual identifier “1abcdef12abcdef1”. Further, the child tag 20 is premised to store a URI “http://pet-smile.net/p/00002/” and an individual identifier “1abcdef12abcdef2”. The parent tag 10 is attached to personal effects such as a bag of the owner and the child tag 20 is mounted on the collar of the pet so as to be attached to the pet. Further, in the following description, it is premised that the information processing device 30 is owned by the owner of the pet and the information processing device 40 is owned by a person who is to read the child tag 20 attached to the pet.

The parent tag 10 and the child tag 20 are related to each other in advance at the time of factory shipment. Then, as shown in FIG. 2, a URI, a parent-child identifier, an individual identifier, and a corresponding URI are stored into the tag DB 52 for each of the parent tag 10 and the child tag 20. Here, it is premised that nothing is stored in the pet DB 53 and the message DB 54.

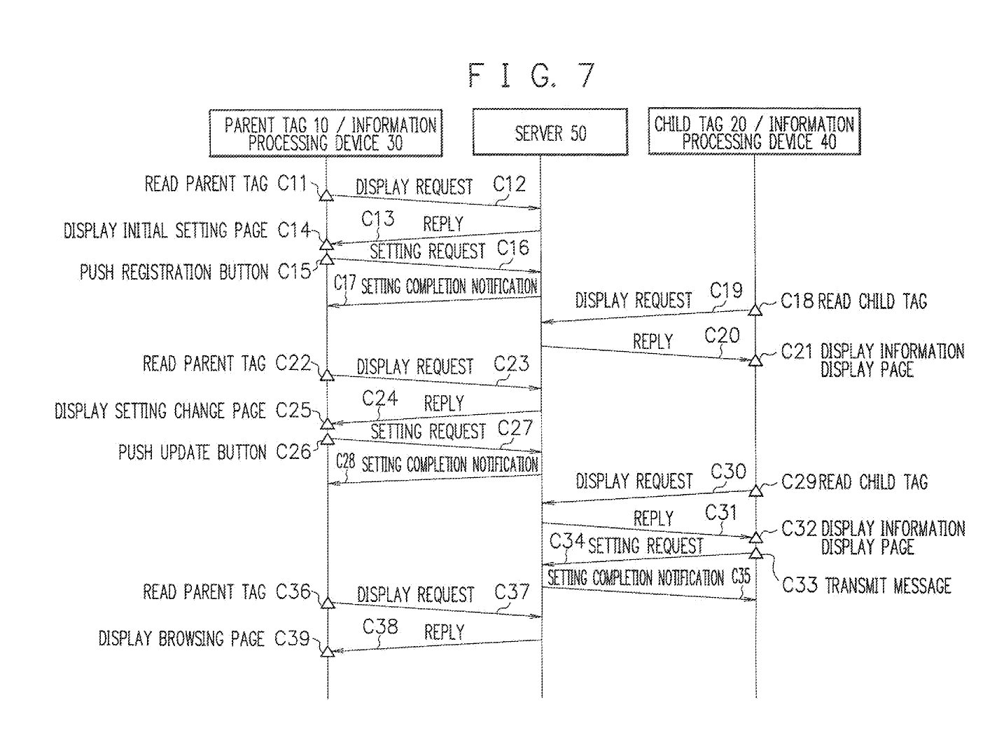

FIG. 7 is a sequence diagram showing operation of the information display system 1.

First, operation at the time of initial setting is described below.

When the owner of the pet holds above the parent tag 10 the information processing device 30 owned by oneself, the short distance wireless communication section 31 of the information processing device 30 performs short distance wireless communication with the short distance wireless communication section 12 in the parent tag 10 and thereby receives from the parent tag 10 the URI “http://pet-smile.net/p/00001/” and the individual identifier “1abcdef12abcdef1” stored in the storage section 11 (step C11). The short distance wireless communication section 31 outputs to the processing section 34 the URI and the individual identifier having been received.

The processing section 34 transmits through the communication section 33 to the server 50 a display request containing: the URI and the individual identifier inputted from the short distance wireless communication section 31; and the type (GET) of the request (step C12).

In the server 50, when receiving through the communication section 51 the display request transmitted from the information processing device 30, the processing section 55 starts the processing shown in FIG. 5.

First, the processing section 55 searches the tag DB 52 with adopting the received URI “http://pet-smile.net/p/00001/” as a search key and thereby acquires from the tag DB 52 the parent-child identifier, the individual identifier, and the corresponding URI stored in a manner of being related to a URI equal to the received URI. As shown in FIG. 2, in the tag DB 52, the parent-child identifier “1”, the individual identifier “1abcdef12abcdef1”, and the corresponding URI “http://pet-smile.net/p/00002/” are stored in a manner of being related to the URI “http://pet-smile.net/p/00001/” equal to the received URI. Thus, the processing section 55 acquires these information pieces from the tag DB 52 (step A12).

Then, since the acquired parent-child identifier is 1, the processing section 55 judges that the read-out tag is a parent tag (step A13: Yes).

Then, in the processing section 55, the received individual identifier “1abcdef12abcdef1” and the acquired individual identifier “1abcdef12abcdef1” agree with each other (step A14: Yes). Thus, the processing section 55 searches the message DB 54 with adopting the received URI as a search key (step A15). As described above, nothing is stored in the message DB 54 and hence nothing is retrieved.

Then, the processing section 55 searches the pet DB 53 with adopting the acquired corresponding URI as a search key and thereby acquires a name, a photograph, a sex, a birth date, a classification, a display message, and a form display stored in a manner of being related to the URI “http://pet-smile.net/p/00002/” equal to the acquired corresponding URI (step A16). As described above, nothing is stored in the pet DB 53 and hence nothing is retrieved.

Referring to FIG. 7 again, the processing section 55 transmits a reply to the display request through the communication section 51 to the information processing device 30 (step C13). Here, the processing section 55 transmits a notification message “null”, a name “null”, a photograph “null”, a sex “null”, a birth date “null”, a classification “null”, a display message “null”, and a form display “null” as a reply to the display request.

In the information processing device 30, the processing section 34 receives through the communication section 33 the reply to the display request transmitted from the server 50.

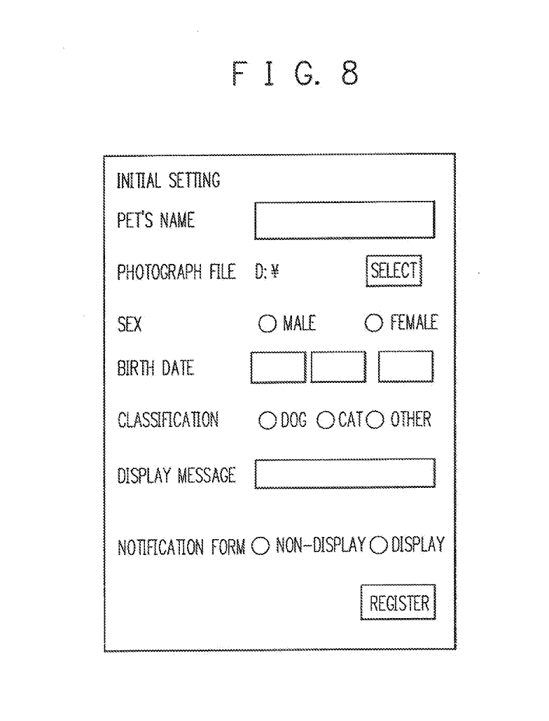

Then, since all items in the reply to the display request are null, the processing section 34 displays on the display/input section 32 an initial setting page shown in FIG. 8. The initial setting page contains fields used for input or selection of the pet's name, the photograph, the sex, the birth date, the classification, the display message, and the form display. Here, since all items in the reply to the display request are null, as shown in FIG. 8, the input fields in the initial setting page are all blank or not yet set up.

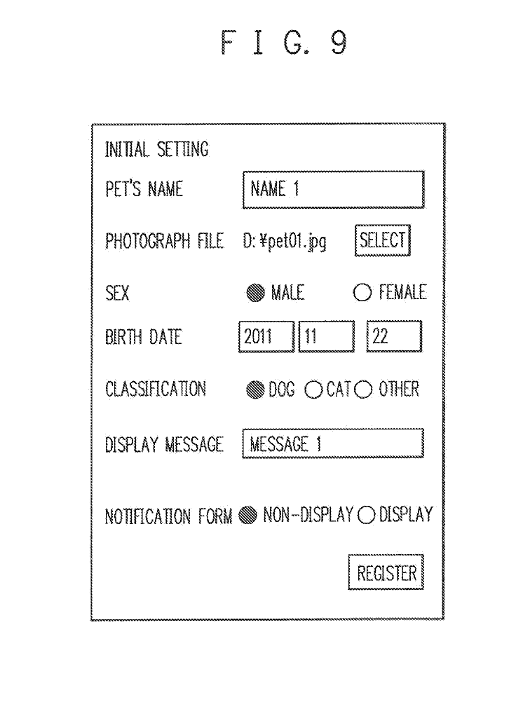

As shown in FIG. 9, it is premised that input into the items has been performed in accordance with the initial setting page by the owner. In this state, when operation input of pushing the registration button is performed through the display/input section 32 (step C15), the processing section 34 transmits through the communication section 33 to the server 50 a setting request containing: the URI “http://pet-smile.net/p/00001/” and the individual identifier “1abcdef12abcdef1” read from the parent tag 10; the contents having been set up in the items; and the type (POST) of the request (step C16).

In the server 50, when receiving through the communication section 51 the setting request transmitted from the information processing device 30, the processing section 55 starts the processing shown in FIG. 6.

First, the processing section 55 searches the tag DB 52 with adopting the received URI as a search key and thereby acquires the parent-child identifier, the individual identifier, and the corresponding URI stored in a manner of being related to the URI “http://pet-smile.net/p/00001/” equal to the received URI. As described above, in the tag DB 52, the parent-child identifier “1”, the individual identifier “1abcdef12abcdef1”, and the corresponding URI “http://pet-smile.net/p/00002/” are stored in a manner of being related to the URI “http://pet-smile.net/p/00001/”. Thus, the processing section 55 acquires these information pieces from the tag DB 52 (step B12).

Then, since the acquired parent-child identifier is 1, the processing section 55 judges that the read-out tag is a parent tag (step B13: Yes).

Then, in the processing section 55, the received individual identifier “1abcdef12abcdef1” and the acquired individual identifier “1abcdef12abcdef1” agree with each other (step B14: Yes). Thus, the processing section 55 searches the pet DB 53 with adopting the acquired corresponding URI “http://pet-smile.net/p/00002/” as a search key, then sets up the contents of the items contained in the setting request into the name, the photograph, the sex, the birth date, the classification, the display message, and the form display stored in a manner of being related to the URI “http://pet-smile.net/p/00002/” equal to the acquired corresponding URI, and thereby updates the pet DB 53 (step B15). Specifically, as shown in FIG. 3, in the pet DB 53, in a manner of being related to the URI “http://pet-smile.net/p/00002/”, the processing section 55 stores “name 1” into the name, “1” into the sex, “2011/11/22” into the birth date, “0” into the classification, “message 1” into the display message, and “0” into the form display. Further, the processing section 55 converts the file name “pet01.jpg” of a photograph of the pet selected by the owner into a file name “00002.jpg” assigned by the system and then stores the data into the pet DB 53. As a result, as shown in FIG. 3, in a manner of being related to the URI “http://pet-smile.net/p/00002”, the name, the photograph, the sex, the birth date, the classification, the display message, and the form display are stored in the pet DB 53.

Referring to FIG. 7 again, the processing section 55 transmits through the communication section 51 to the information processing device 30 a setting completion notification indicating that setting has been completed (step C17).

In the information processing device 30, when receiving the setting completion notification transmitted from the server 50, the processing section 34 displays on the display/input section 32 a situation that setting has been completed.

By virtue of the processing of steps C11 to C17 described above, initial setting is completed.

Next, operation at the time of read of the child tag 20 is described below.

When the owner of the information processing device 40 holds above the child tag 20 the information processing device 40, the short distance wireless communication section 41 of the information processing device 40 performs short distance wireless communication with the short distance wireless communication section 22 in the child tag 20 and thereby receives from the child tag 20 the URI “http://pet-smile.net/p/00002/” and the individual identifier “1abcdef12abcdef2” stored in the storage section 21 (step C18). The short distance wireless communication section 41 outputs to the processing section 44 the URI and the individual identifier having been received.

The processing section 44 transmits through the communication section 43 to the server 50 a display request containing: the URI inputted from the short distance wireless communication section 41; and the type (GET) of the request (step C19).

In the server 50, when receiving through the communication section 51 the display request transmitted from the information processing device 40, the processing section 55 starts the processing shown in FIG. 5.

First, the processing section 55 searches the tag DB 52 with adopting the received URI “http://pet-smile.net/p/00002/” as a search key and thereby acquires the parent-child identifier, the individual identifier, and the corresponding URI stored in a manner of being related to a URI equal to the received URI. As shown in FIG. 2, in the tag DB 52, the parent-child identifier “0”, the individual identifier “1abcdef12abcdef2”, and the corresponding URI “http://pet-smile.net/p/00001/” are stored in a manner of being related to the URI “http://pet-smile.net/p/00002/” equal to the received URI. Thus, the processing section 55 acquires these information pieces from the tag DB 52 (step A12).

Then, since the acquired parent-child identifier is 0, the processing section 55 judges that the read-out tag is a child tag (step A13: No).

Then, the processing section 55 searches the pet DB 53 shown in FIG. 3 with adopting the received URI as a search key and thereby acquires the name “name 1”, the photograph “00002.jp9”, the sex “1”, the birth date “2011/11/22”, the classification “0”, the display message “message 1”, and the form display “1” stored in a manner of being related to the URI “http://pet-smile.net/p/00002/” equal to the received URI.

Referring to FIG. 7 again, the processing section 55 transmits information indicating the name, the photograph, the sex, the birth date, the classification, the display message, and the form display having been acquired, through the communication section 51 to the information processing device 40 as a reply to the display request (step C20). Here, the processing section 55 transmits the information such as the name, in a format (e.g., HTML (Hyper Text Markup Language) format) which can be employed in display on the information processing device 40.

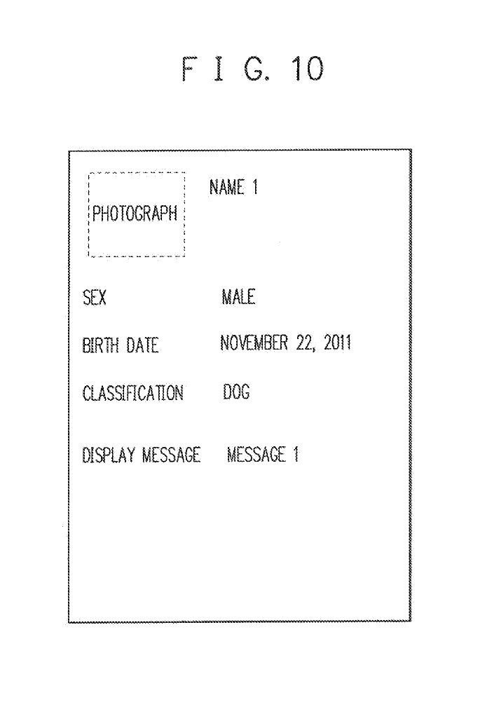

In the information processing device 40, the processing section 44 receives through the communication section 43 the information transmitted from the server 50 as a reply to the display request. Then, as shown in FIG. 10, the processing section 44 displays on the display/input section 42 an information display page displaying the name, the photograph, the sex, the birth date, the classification, and the display message indicated in the received information (step C21). Here, since the form display indicated in the received information is 0, the processing section 44 does not display the notification form.

By virtue of the processing of steps C18 to C21 described above, in accordance with the reading of the child tag 20, the information corresponding to the child tag 20 is displayed on the information processing device 40.

Next, operation at the time of update of the pet DB 53 is described below. In the following description, it is premised that the pet has become missing and hence the owner of the pet is to change the information corresponding to the child tag 20.

When the owner of the pet holds above the parent tag 10 the information processing device 30 owned by oneself, the short distance wireless communication section 31 of the information processing device 30 performs short distance wireless communication with the short distance wireless communication section 12 in the parent tag 10 and thereby receives from the parent tag 10 the URI “http://pet-smile.net/p/00001/” and the individual identifier “1abcdef12abcdef1” stored in the storage section 11 (step C22). The short distance wireless communication section 31 transmits through the communication section 33 to the server 50 a display request containing: the URI and the individual identifier having been received; and the type (GET) of the request (step C23). In the server 50, when receiving through the communication section 51 the display request transmitted from the information processing device 30, the processing section 55 starts the processing shown in FIG. 5.

First, the processing section 55 searches the tag DB 52 with adopting the received URI “http://pet-smile.net/p/00001/” as a search key and thereby acquires from the tag DB 52 the parent-child identifier, the individual identifier, and the corresponding URI stored in a manner of being related to a URI equal to the received URI. As shown in FIG. 2, in the tag DB 52, the parent-child identifier “1”, the individual identifier “1abcdef12abcdef1”, and the corresponding URI “http://pet-smile.net/p/00002/” are stored in a manner of being related to the URI “http://pet-smile.net/p/00001/” equal to the received URI. Thus, the processing section 55 acquires these information pieces from the tag DB 52 (step A12).

Then, since the acquired parent-child identifier is 1, the processing section 55 judges that the read-out tag is a parent tag (step A13: Yes).

Then, in the processing section 55, the received individual identifier “1abcdef12abcdef1” and the acquired individual identifier “1abcdef12abcdef1” agree with each other (step A14: Yes). Thus, the processing section 55 searches the message DB 54 with adopting the received URI as a search key (step A15). As described above, nothing is stored in the message DB 54 and hence nothing is retrieved.

Then, the processing section 55 searches the pet DB 53 with adopting the acquired corresponding URI as a search key and thereby acquires the name “name 1”, the photograph “00002.jp9”, the sex “1”, the birth date “2011/11/22”, the classification “0”, the display message “message 1”, and the form display “0” stored in a manner of being related to the URI “http://pet-smile.net/p/00002/” equal to the acquired corresponding URI (step A16).

Referring to FIG. 7 again, the processing section 55 transmits a reply to the display request through the communication section 51 to the information processing device 30 (step C24). Here, the processing section 55 transmits the notification message “null”, the name “name 1”, the photograph “pet001.jpg”, the sex “I”, the birth date “2011/11/22”, the classification “0”, the display message “message 1”, and the form display “0)” as a reply to the display request. Here, the processing section 55 converts the file name “00002.jpg” of the photograph assigned by the system into the file name “pet01.jpg” of the photograph of the pet selected by the owner and then transmits the data to the information processing device 30.

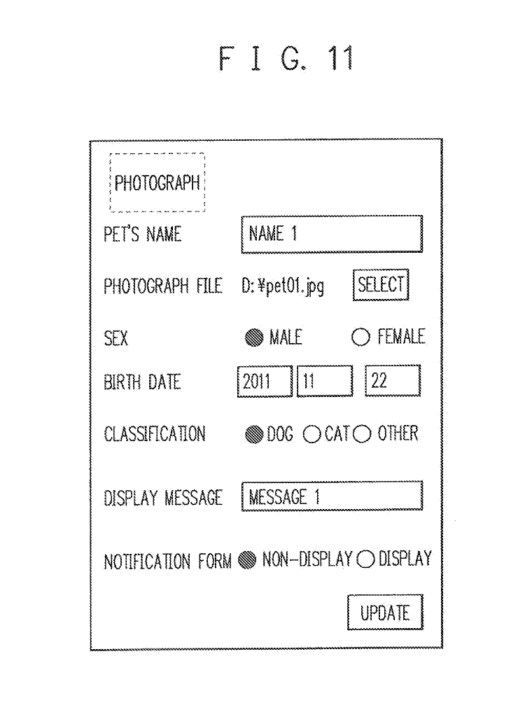

In the information processing device 30, the processing section 34 receives through the communication section 33 the correspondence corresponding to the display request transmitted from the server 50. Then, on the basis of the reply from the server 50, the processing section 34 displays on the display/input section 32 a setting change page shown in FIG. 11 (step C25). As shown in FIG. 11, in the setting change page, the contents indicated in the reply from the server 50 are displayed in the items of name, photograph, sex, birth date, classification, display message, and notification form.

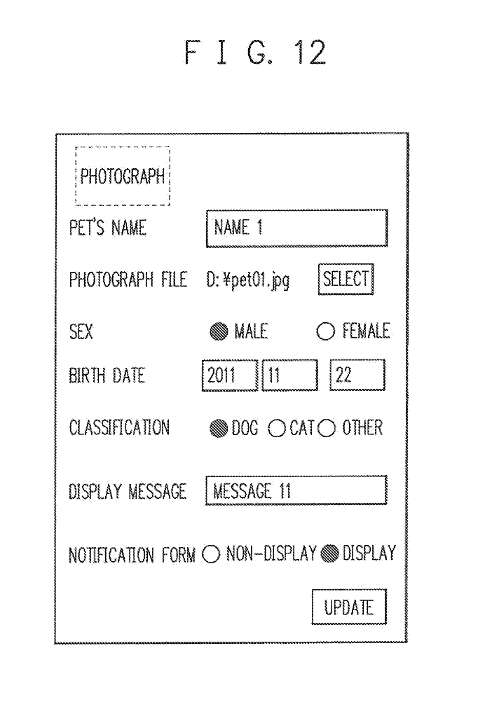

It is premised that in accordance with the setting change page, as shown in FIG. 12, the display message has been changed by the owner into “message 11 (a message that the pet has been missing and hence a notification from the finder is requested)” and then the notification form is changed into “display”. In this state, when operation input of pushing the update button is performed through the display/input section 32 (step C26), the processing section 34 transmits through the communication section 33 to the server 50 a setting request containing: the URI “http://pet-smile.net/p/00001/” and the individual identifier “1abcdef12abcdef1” read from the parent tag 10; the contents having been set up in the items; and the type (POST) of the request (step C27). In the server 50, when receiving through the communication section 51 the setting request transmitted from the information processing device 30, the processing section 55 starts the processing shown in FIG. 6.

First, the processing section 55 searches the tag DB 52 with adopting the received URI as a search key and thereby acquires the parent-child identifier, the individual identifier, and the corresponding URI stored in a manner of being related to a URI equal to the received URI. As shown in FIG. 2, in the tag DB 52, the parent-child identifier “1”, the individual identifier “1abcdef12abcdef1”, and the corresponding URI “http://pet-smile.net/p/00002/” are stored in a manner of being related to the URI “http://pet-smile.net/p/00001/” equal to the received URI. Thus, the processing section 55 acquires these information pieces from the tag DB 52 (step B12).

Then, since the acquired parent-child identifier is 1, the processing section 55 judges that the read-out tag is a parent tag (step B13: Yes).

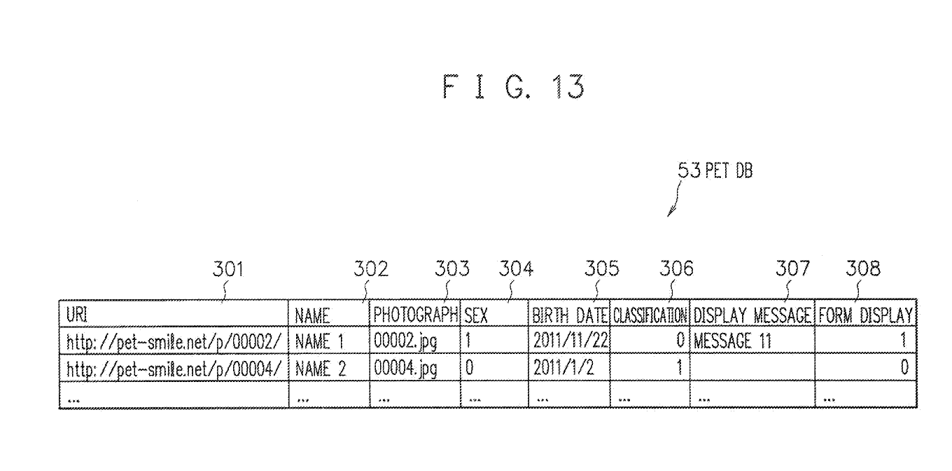

Then, in the processing section 55, the received individual identifier “1abcdef12abcdef1” and the acquired individual identifier “1abcdef12abcdef1” agree with each other (step B14: Yes). Thus, the processing section 55 searches the pet DB 53 with adopting the acquired corresponding URI “http://pet-smile.net/p/00002/” as a search key, then changes into the contents of the items contained in the setting request the name, the photograph, the sex, the birth date, the classification, the display message, and the form display stored in a manner of being related to the URI “http://pet-smile.net/p/00002/” equal to the acquired corresponding URI, and thereby updates the pet DB 53 (step B51). Specifically, as shown in FIG. 13, the processing section 55 changes the display message into “message 11” and changes the form display into “1”.

Referring to FIG. 7 again, the processing section 55 transmits through the communication section 51 to the information processing device 30 a setting completion notification indicating that setting has been completed (step C28).

By virtue of the processing of steps C22 to C28 described above, the pet DB 53 can be updated.

Next, operation at the time of write of the notification message to the owner is described below. In the following description, it is premised that a person who has found the pet having become missing (the owner of the information processing device 40) is to transmit a notification message to the owner of the pet.

When the owner of the information processing device 40 holds above the child tag 20 attached to the pet the information processing device 40 owned by oneself, the short distance wireless communication section 41 of the information processing device 40 performs short distance wireless communication with the short distance wireless communication section 22 in the child tag 20 and thereby receives from the child tag 20 the URI “http://pet-smile.net/p/00002/” and the individual identifier “1abcdef12abcdef2” stored in the storage section 21 (step C29). The short distance wireless communication section 41 outputs to the processing section 44 the URI and the individual identifier having been received.

The processing section 44 transmits through the communication section 43 to the server 50 a display request containing: the URI inputted from the short distance wireless communication section 41; and the type (GET) of the request (step C30).

In the server 50, when receiving through the communication section 51 the display request transmitted from the information processing device 40, the processing section 55 starts the processing shown in FIG. 5.

First, the processing section 55 searches the tag DB 52 with adopting the received URI “http://pet-smile.net/p/00002” as a search key and thereby acquires the parent-child identifier, the individual identifier, and the corresponding URI stored in a manner of being related to a URI equal to the received URI. As shown in FIG. 2, in the tag DB 52, the parent-child identifier “0”, the individual identifier “1abcdef12abcdef2”, and the corresponding URI “http://pet-smile.net/p/00001/” are stored in a manner of being related to the URI “http://pet-smile.net/p/00002” equal to the received URI. Thus, the processing section 55 acquires these information pieces from the tag DB 52 (step A12).

Then, since the acquired parent-child identifier is 0, the processing section 55 judges that the read-out tag is a child tag (step A13: No).

Then, the processing section 55 searches the pet DB 53 with adopting the received URI as a search key and thereby acquires the information stored in a manner of being related to a URI equal to the received URI. As shown in FIG. 13, in the pet DB 53, in a manner of being related to the URI “http://pet-smile.net/p/00002/” equal to the received URI, the name “name 1”, the photograph “00002.jp9”, the sex “1”, the birth date “2011/11/22”, the classification “0”, the display message “message 11”, and the form display “1” are stored. Thus, the processing section 55 acquires these information pieces from the pet DB 53.

Referring to FIG. 7 again, the processing section 55 transmits information indicating the name, the photograph, the sex, the birth date, the classification, the display message, and the form display having been acquired, through the communication section 51 to the information processing device 40 as a reply to the display request (step C31).

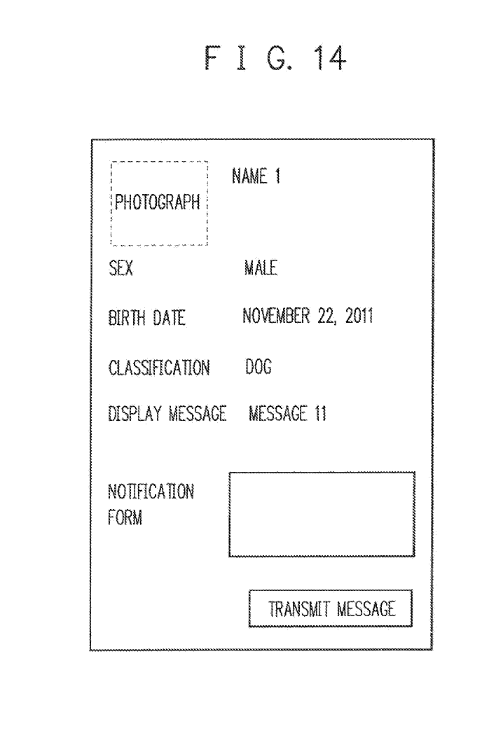

In the information processing device 40, the processing section 44 receives through the communication section 43 the information transmitted from the server 50 as a reply to the display request. Then, as shown in FIG. 14, the processing section 44 displays on the display/input section 42 an information display page displaying the name, the photograph, the sex, the birth date, the classification, the display message, and the notification form indicated in the received information (step C32). Here, since the form display indicated in the information transmitted from the server 50 is 1, the processing section 44 display the notification form also.

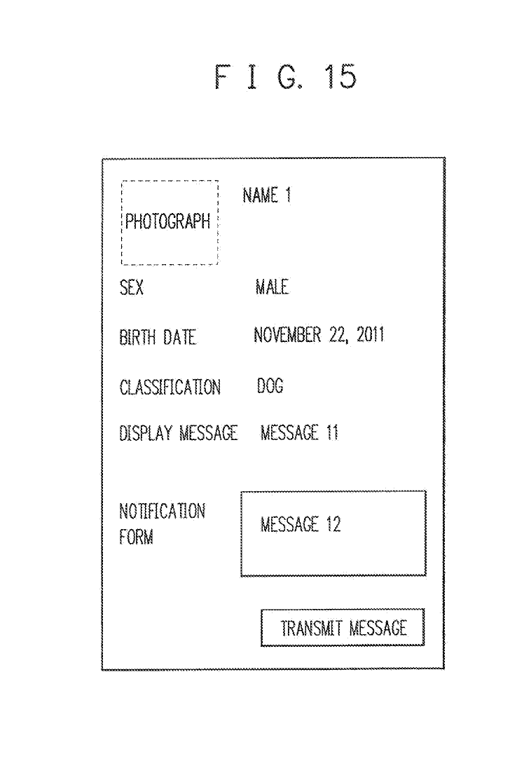

It is premised that in accordance with the information display page shown in FIG. 14, as shown in FIG. 15, the finder of the pet has inputted “message 12 (a message stating that the pet has been found and describing a contact destination)” as a notification message into the notification form. In this state, when operation input of pushing the message transmission button is performed through the display/input section 42 (step C33), the processing section 44 transmits through the communication section 43 to the server 50 a setting request containing: the URI “http://pet-smile.net/p/00002/” read from the child tag 20; the inputted notification message; and the type (POST) of the request (step C34).

In the server 50, when receiving through the communication section 51 the setting request transmitted from the information processing device 40, the processing section 55 starts the processing shown in FIG. 6.

First, the processing section 55 searches the tag DB 52 with adopting the received URI as a search key and thereby acquires the parent-child identifier, the individual identifier, and the corresponding URI stored in a manner of being related to a URI equal to the received URI. As shown in FIG. 2, in the tag DB 52, the parent-child identifier “0”, the individual identifier “1abcdef12abcdef2”, and the corresponding URI “http://pet-smile.net/p/00001/” are stored in a manner of being related to the URI “http://pet-smile.net/p/00002/” equal to the received URI. Thus, the processing section 55 acquires these information pieces from the tag DB 52 (step B12).

Then, since the acquired parent-child identifier is 1, the processing section 55 judges that the read-out tag is a child tag (step B13: No).

Then, the processing section 55 searches the message DB 54 with adopting the acquired corresponding URI “http://pet-smile.net/p/00001/” as a search key, then stores the notification message “message 12” contained in the setting request into the message DB 54 in a manner of being related to the URI “http://pet-smile.net/p/00001/” equal to the acquired corresponding URI, and thereby updates the message DB 54 (step B18). Referring to FIG. 7 again, the processing section 55 transmits through the communication section 51 to the information processing device 40 a setting completion notification indicating that setting has been completed (step C35).

By virtue of the processing of steps C29 to C35 described above, the write of the notification message to the owner is completed.

Next, operation at the time of browsing of the notification message from the finder of the pet is described below.

When the owner of the pet holds above the parent tag 10 the information processing device 30 owned by oneself, the short distance wireless communication section 31 of the information processing device 30 performs short distance wireless communication with the short distance wireless communication section 12 in the parent tag 10 and thereby receives from the parent tag 10 the URI “http://pet-smile.net/p/00001/” and the individual identifier “1abcdef12abcdef1” stored in the storage section 11 (step C36). The short distance wireless communication section 31 outputs to the processing section 34 the URI and the individual identifier having been received.

The processing section 34 transmits through the communication section 33 to the server 50 a display request containing: the URI and the individual identifier inputted from the short distance wireless communication section 31; and the type (GET) of the request (step C37).

In the server 50, when receiving through the communication section 51 the display request transmitted from the information processing device 30, the processing section 55 starts the processing shown in FIG. 5.

First, the processing section 55 searches the tag DB 52 with adopting the received URI “http://pet-smile.net/p/00001/” as a search key and thereby acquires from the tag DB 52 the parent-child identifier, the individual identifier, and the corresponding URI stored in a manner of being related to a URI equal to the received URI. As shown in FIG. 2, in the tag DB 52, the parent-child identifier “1”, the individual identifier “1abcdef12abcdef1”, and the corresponding URI “http://pet-smile.net/p/00002/” are stored in a manner of being related to the URI “http://pet-smile.net/p/00001/” equal to the received URI. Thus, the processing section 55 acquires these information pieces from the tag DB 52 (step A12).

Then, since the acquired parent-child identifier is 1, the processing section 55 judges that the read-out tag is a parent tag (step A13: Yes).

Then, in the processing section 55, since the received individual identifier “1abcdef12abcdef1” and the acquired individual identifier “1abcdef12abcdef1” agree with each other (step A14: Yes), the processing section 55 searches the message DB 54 with adopting the received URI as a search key and thereby acquires a notification message stored in a manner of being related to a URI equal to the received URI (step A15). As shown in FIG. 4, in the message DB 54, the notification message “message 12 (a message stating that the pet has been found and describing a contact destination)” is stored in a manner of being related to the URI “http://pet-smile.net/p/00001/”. Thus, the processing section 55 acquires this notification message.

Then, the processing section 55 searches the pet DB 53 with adopting the acquired corresponding URI as a search key and thereby acquires the name “name 1”, the photograph “00002.jpg”, the sex “1”, the birth date “2011/11/22”, the classification “0”, the display message “message 11”, and the form display “1” stored in a manner of being related to the URI “http://pet-smile.net/p/00002/” equal to the acquired corresponding URI as shown in FIG. 13 (step A16).

Referring to FIG. 7 again, the processing section 55 transmits information indicating the notification message, the name, the photograph, the sex, the birth date, the classification, the display message, and the form display having been acquired, through the communication section 51 to the information processing device 30 as a reply to the display request (step C38).

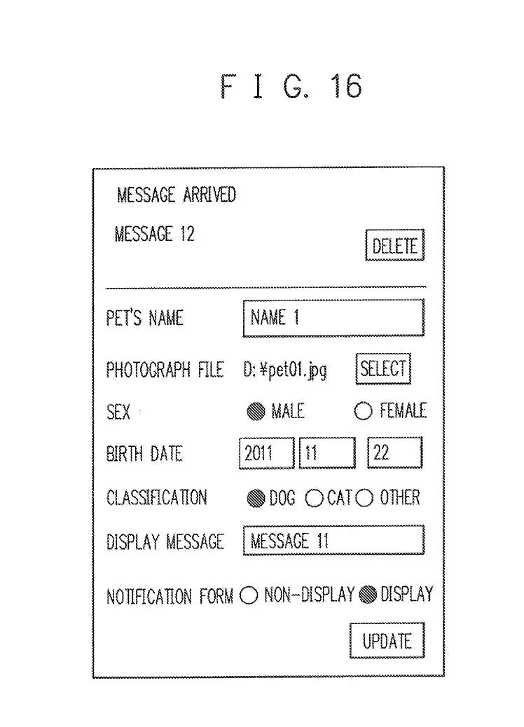

In the information processing device 30, the processing section 34 receives through the communication section 33 the information transmitted from the server 50 as a reply to the display request. Then, as shown in FIG. 16, the processing section 34 displays on the display/input section 32 a browsing page displaying the notification message, the setting of the name, the photograph, the sex, the birth date, the classification, the display message, and the form display indicated in the received information.

By virtue of the processing of steps C36 to C39 described above, the owner of the pet can browse the notification message from the finder of the pet.

As such, according to the information processing system 1 of the present embodiment, the server 50 includes: a first storage section (the tag DB 52) for storing the identifier of the parent tag 10 and the identifier of the child tag 20 corresponding to the parent tag 10 in a manner of being related to each other, and a second storage section (the pet DB 53 and the message DB 54) for storing information corresponding to each tag in a manner of being related to each of the identifier of the parent tag 10 and the identifier of the child tag 20. Then, when receiving from the information processing device an acquisition request containing the identifier of the parent tag 10 or the identifier of the child tag 20, in accordance with the acquisition request, the server 50 transmits, to the information processing device, information stored in the second storage section in a manner of being related to the identifier of the parent tag 10 or the identifier of the child tag 20 and, when receiving a setting request containing the identifier of a tag from the information processing device, stores the information requested in the setting request into the second storage section in a manner of being related to the identifier of the tag that is in the parent-child relationship with the tag. Further, when information has been transmitted from the server, the information processing devices 30 and 40 display the information on the display section and the input section.

Thus, when the identifier of the parent tag 10 is merely read by using the information processing device and then the information is merely transmitted to the server 50, the information corresponding to the child tag 20 that is in the parent-child relationship with the parent tag 10 can be changed. Accordingly, without the necessity of administering the ID and the password used for changing the information, the information corresponding to the child tag can be changed flexibly and simply. Further, only the owner of the parent tag 10 can change the information corresponding to the child tag 20. This avoids a situation that the information is changed by an unauthorized person as a result of leakage of the ID and the password.

Here, in the present embodiment, the present invention has been described for an example that the parent tag 10 is owned by the owner of the pet and the child tag 20 is attached to the pet. However, employable configurations are not limited to this. For example, the parent tag 10 may be owned by a person such as the owner of an article and the child tag 20 may be attached to the article of the owner. Further, the parent tag 10 may be owned by a person such as a tour guide and a guardian and the child tag 20 may be owned by a person such as a tourist, an elderly person, and a child.

### Second Embodiment

In the information display system 1 of the first embodiment, at the time that the information corresponding to the child tag 20 that is in the parent-child relationship with the parent tag 10 is to be changed, authentication has been performed by using the individual identifier of the parent tag 10. In the information display system of a second embodiment of the present invention, authentication is performed also at the time of browsing of the information corresponding to the child tag 20 so that unauthorized access to the information corresponding to the child tag is avoided.

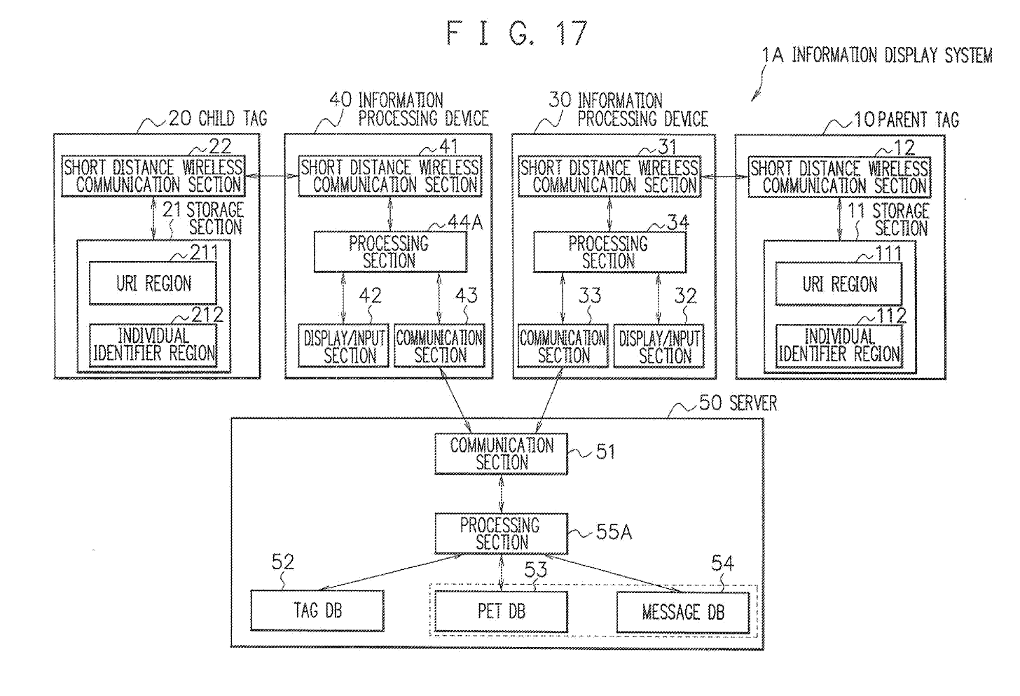

FIG. 17 is a diagram showing the configuration of an information display system 1A of the present embodiment. In FIG. 17, like configurations to those in FIG. 1 are designated by like numerals and hence their description is omitted.

The information display system 1A of the present embodiment is different from the information display system 1 of the first embodiment in the points that the processing section 44 in the information processing device 40 is changed into the processing section 44A and that the processing section 55 in the server 50 is changed into the processing section 55A.

Similarly to the processing section 34 of the information processing device 30, the processing section 44A is provided with a tag authentication application and then, when receiving through the short distance wireless communication section 41 the URI and the individual identifier having been set up in the tag, transmits a request containing the URI and the individual identifier to the server 50.

When receiving the request from the information processing device, the processing section 55A performs authentication on the basis of the received individual identifier and then performs processing corresponding to the request.

Next, operation of the processing section 55A is described below.

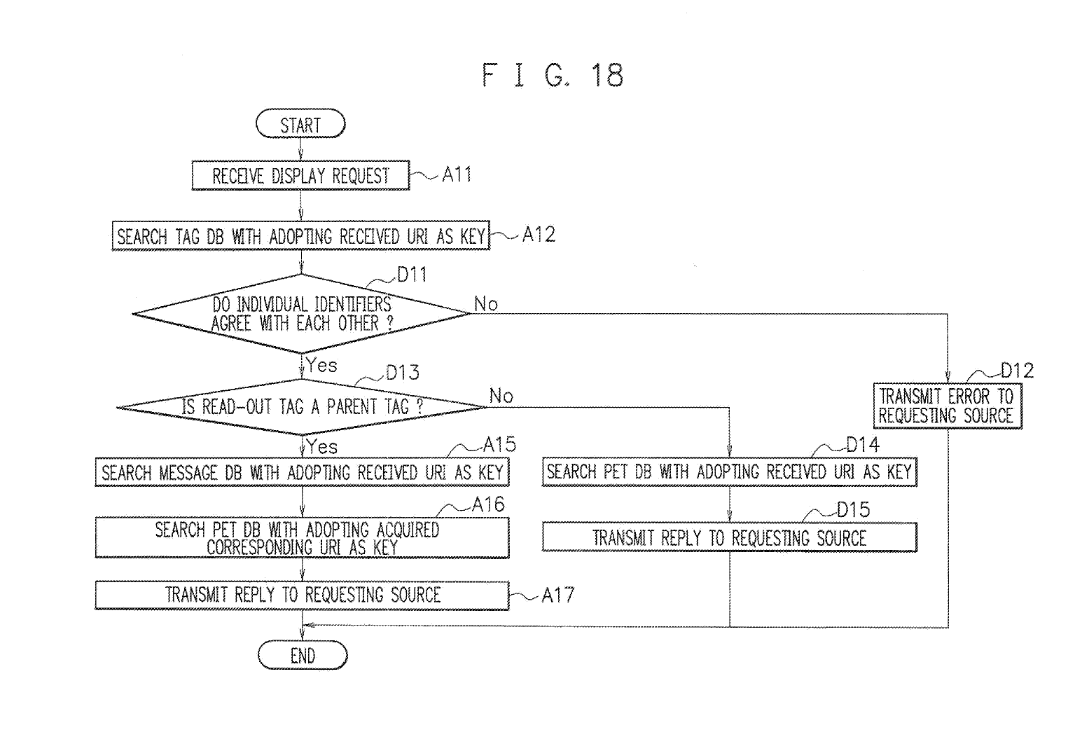

First, operation of the processing section 55A at the time of receiving of a display request is described below with reference to the flow chart shown in FIG. 18. In FIG. 18, like processing to one in FIG. 5 is designated by a like numeral and hence its description is omitted.

When a display request has been transmitted from the information processing device, the processing section 55A receives the display request through the communication section 51 (step A11).

Then, the processing section 55A searches the tag DB 52 with adopting the received URI as a search key and thereby acquires from the tag DB 52 the parent-child identifier, the individual identifier, and the corresponding URI stored in a manner of being related to a URI equal to the received URI (step A12).

Then, the processing section 55A judges whether the received individual identifier and the acquired individual identifier agree with each other (step D11).

When the received individual identifier and the acquired individual identifier do not agree with each other (step D11: No), the processing section 55A transmits an error through the communication section 51 to the information processing device of requesting source (step D12) and then terminates the processing.

When the received individual identifier and the acquired individual identifier agree with each other (step D11: Yes), on the basis of the parent-child identifier acquired from the tag DB 52, the processing section 55A judges whether the read-out tag (the tag in which the received URI has been set up) is a parent tag (step D13).

When the read-out tag is a parent tag (when the parent-child identifier is 1) (step D13: Yes), the processing section 55A goes to the processing of step A15.

When the read-out tag is a child tag (when the acquired parent-child identifier is 0) (step D13: No), the processing section 55A searches the pet DB 53 with adopting the received URI as a search key and thereby acquires a name, a photograph, a sex, a birth date, a classification, a display message, and a form display stored in a manner of being related to a URI equal to the received URI (step D14).

Then, the processing section 55A transmits information indicating the name, the photograph, the sex, the birth date, the classification, the display message, and the form display acquired at step D14, to the information processing device of requesting source as a reply to the display request (step D15) and then terminates the processing.

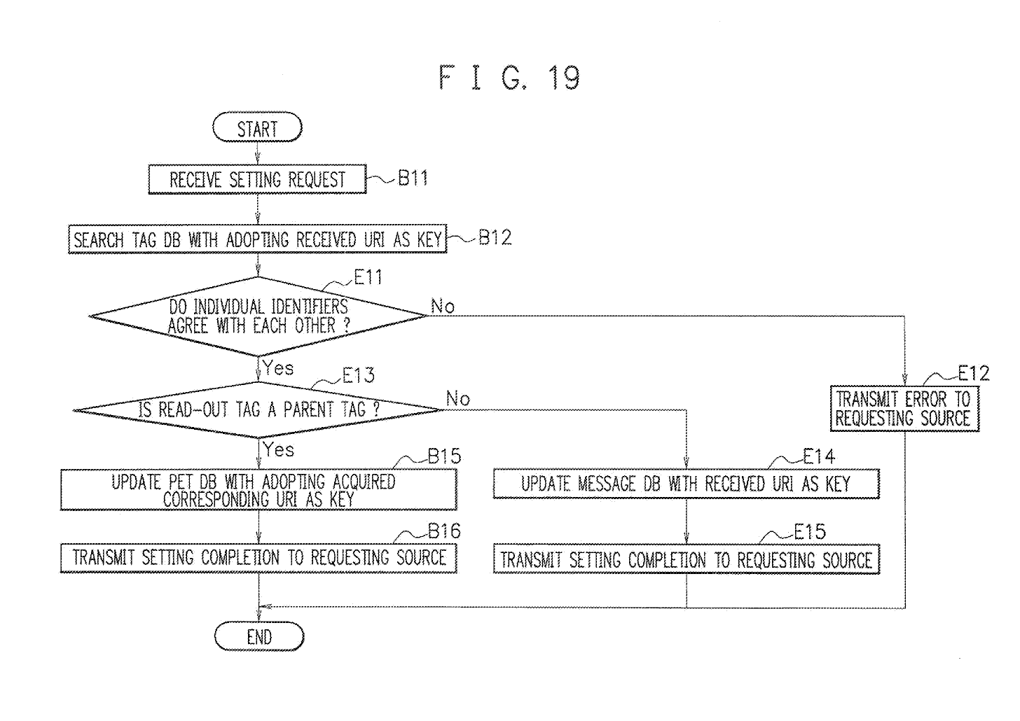

Then, operation of the processing section 55A at the time of receiving of a setting request is described below with reference to the flow chart shown in FIG. 19. In FIG. 19, like processing to one in FIG. 6 is designated by a like numeral and hence its description is omitted.

When a setting request has been transmitted from the information processing device, the processing section 55A receives the setting request through the communication section 51 (step B11).

Then, the processing section 55 searches the tag DB 52 with adopting the received URI as a search key and thereby acquires from the tag DB 52 the parent-child identifier, the individual identifier, and the corresponding URI stored in a manner of being related to a URI equal to the received URI (step B12).

Then, the processing section 55A judges whether the received individual identifier and the acquired individual identifier agree with each other (step E11).

When the received individual identifier and the acquired individual identifier do not agree with each other (step E11: No), the processing section 55A transmits an error to the information processing device of requesting source (step E12) and then terminates the processing.

When the received individual identifier and the acquired individual identifier agree with each other (step E11: Yes), on the basis of the parent-child identifier acquired from the tag DB 52, the processing section 55A judges whether the read-out tag (the tag in which the received URI has been set up) is a parent tag (step E13).

When the read-out tag is a parent tag (when the parent-child identifier is 1) (step E13: Yes), the processing section 55A goes to the processing of step B15.

When the read-out tag is a child tag (when the acquired parent-child identifier is 0) (step E13: No), the processing section 55A searches the message DB 54 with adopting the received URI as a search key and then receives from the information processing device of requesting source the setting of the notification message corresponding to the retrieved URI. Further, the processing section 55 updates the message DB 54 (stores the set-up notification message into the message DB 54 in a manner of being related to the retrieved URI) (step E14), then transmits to the requesting source a situation indicating that setting has been completed (step E15), and then terminates the processing.

As such, according to the information display system 1A of the present embodiment, the information processing devices 30 and 40 transmits to the server 50 a request containing the URI and the individual identifier having been read from the tag. Then, not only when change of the information corresponding to the child tag 20 has been requested but also when browsing of the information corresponding to the child tag 20 has been requested, the server 50 performs authentication on the basis of the individual identifier.

Thus, unauthorized access to the information corresponding to the child tag 20 can be avoided.

Here, in the present embodiment, the present invention has been described for an example that the parent tag 10 is owned by the owner of the pet and the child tag 20 is attached to the pet. However, employable configurations are not limited to this. For example, the parent tag 10 may be owned by a person such as the owner of an article and the child tag 20 may be attached to the article of the owner. Further, the parent tag 10 may be owned by a person such as a tour guide and a guardian and the child tag 20 may be owned by a person such as a tourist, an elderly person, and a child.

The method performed in the server of the present invention may be applied to a program executed on a computer. Further, the program may be stored in a storage medium and may be provided through a network to the outside.

The invention of the present patent application has been described above with reference to the embodiments. However, the present invention is not limited to the embodiments given above. Various changes which can be understood by the person skilled in the art within the scope of the invention of the present patent application may be made on the configurations and the details of the invention of the present patent application.

This application is based upon and claims the benefit of priority from Japanese patent application No. 2012-212476, filed on Sep. 26, 2012, the disclosure of which is incorporated herein its entirety by reference.

A part or all of the embodiments given above may be described as the following additional descriptions. However, the present invention is not limited to these.

### (Additional Description 1)

An information display system including: an information processing device capable of reading an identifier of a tag; and a server capable of performing communication with the information processing device through a network, wherein

the server includes:

a first storage section for storing an identifier of a first tag and an identifier of a second tag corresponding to the first tag, in a manner of being related to each other;

a second storage section for storing information in a manner of being related to each of the identifier of the first tag and the identifier of the second tag; and

a processing section for, when the identifier of the first tag or the identifier of the second tag and an acquisition request for the information corresponding thereto are received from the information processing device, transmitting, to the information processing device, the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request into the second storage section in a manner of being related to the identifier of the other tag, and wherein

the information processing device includes a display section for, when the information has been transmitted from the processing section, displaying contents of the information.

### (Additional Description 2)

The information display system according to additional description 1, wherein

the identifier of the tag is a resource identifier indicating an on-the-network position of a resource having stored the information corresponding to the tag.

(Additional description 3)

The information display system according to additional description 2, wherein:

in the tag, an individual identifier for uniquely identifying the tag is further set up;

the first storage section further stores the individual identifier of the tag in a manner of being related to the resource identifier of the tag; and

when the resource identifier plus the individual identifier of one tag selected from the resource identifier plus the individual identifier of the first tag and the resource identifier plus the individual identifier of the second tag as well as a setting request for the information corresponding to the other tag are received from the information processing device, in a case that the individual identifier stored in the first storage section in a manner of being related to the received resource identifier and the received individual identifier agree with each other, the processing section stores the information requested in the setting request into the second storage section in a manner of being related to the identifier of the other tag.

### (Additional Description 4)

An information display method in an information display system including: an information processing device capable of reading an identifier of a tag; and a server capable of performing communication with the information processing device through a network, wherein

the server:

stores an identifier of a first tag and an identifier of a second tag corresponding to the first tag in a manner of being related to each other;

stores information in a manner of being related to each of the identifier of the first tag and the identifier of the second tag; and

when the identifier of the first tag or the identifier of the second tag and an acquisition request for the information corresponding thereto are received from the information processing device, transmits to the information processing device the information stored in a manner of being related to the received identifier and, when the identifier of one tag selected from the identifier of the first tag and the identifier of the second tag as well as a setting request for the information corresponding to the other tag are received from the information processing device, stores the information requested in the setting request, in a manner of being related to the identifier of the other tag, and wherein

when the information has been transmitted from the server, the information processing device displays contents of the information.

### (Additional Description 5)

A server capable of performing communication, through a network, with an information processing device capable of reading an identifier of a tag, including:

a first storage section for storing an identifier of a first tag and an identifier of a second tag corresponding to the first tag, in a manner of being related to each other;

a second storage section for storing information in a manner of being related to each of the identifier of the first tag and the identifier of the second tag; and

a processing section for, when the identifier of the first tag or the identifier of the second tag and an acquisition request for the information corresponding thereto are received from the information processing device, transmitting, to the information processing device, the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request into the second storage section in a manner of being related to the identifier of the other tag.

### (Additional Description 6)

A control method for a server capable of performing communication, through a network, with an information processing device capable of reading a tag, including:

storing an identifier of a first tag and an identifier of a second tag corresponding to the first tag in a manner of being related to each other;

storing information in a manner of being related to each of the identifier of the first tag and the identifier of the second tag; and

when the identifier of the first tag or the identifier of the second tag and an acquisition request for the information corresponding thereto are received from the information processing device, transmitting to the information processing device the information stored in a manner of being related to the received identifier and, when the identifier of one tag selected from the identifier of the first tag and the identifier of the second tag as well as a setting request for the information corresponding to the other tag are received from the information processing device, storing the information requested in the setting request, in a manner of being related to the identifier of the other tag.

### (Additional Description 7)

A program causing a computer to execute:

the processing of storing an identifier of a first tag and an identifier of a second tag corresponding to the first tag, in a manner of being related to each other;

the processing of storing information in a manner of being related to each of the identifier of the first tag and the identifier of the second tag; and

the processing of, when the identifier of the first tag or the identifier of the second tag and an acquisition request for the information corresponding thereto are received from an information processing device capable of reading a tag, transmitting to the information processing device the information stored in a manner of being related to the received identifier and, when the identifier of one tag selected from the identifier of the first tag and the identifier of the second tag as well as a setting request for the information corresponding to the other tag are received from the information processing device, storing the information requested in the setting request, in a manner of being related to the identifier of the other tag.

1. An information display system comprising: an information processing device capable of reading an identifier of a tag; and a server capable of performing communication with the information processing device through a network, wherein
the server includes:
a first storage section for storing an identifier of a first tag and an identifier of a second tag corresponding to the first tag, in a manner of being related to each other;
a second storage section for storing information in a manner of being related to each of the identifier of the first tag and the identifier of the second tag; and
a processing section for, when the identifier of the first tag or the identifier of the second tag and an acquisition request for the information corresponding thereto are received from the information processing device, transmitting, to the information processing device, the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request into the second storage section in a manner of being related to the identifier of the other tag, and wherein
the information processing device includes a display section for, when the information has been transmitted from the processing section, displaying contents of the information.

2. The information display system according to claim 1, wherein
the identifier of the tag is a resource identifier indicating an on-the-network position of a resource having stored the information corresponding to the tag.

3. The information display system according to claim 2, wherein:
in the tag, an individual identifier for uniquely identifying the tag is further set up;
the first storage section further stores the individual identifier of the tag in a manner of being related to the resource identifier of the tag; and
when the resource identifier plus the individual identifier of one tag selected from the resource identifier plus the individual identifier of the first tag and the resource identifier plus the individual identifier of the second tag as well as a setting request for the information corresponding to the other tag are received from the information processing device, in a case that the individual identifier stored in the first storage section in a manner of being related to the received resource identifier and the received individual identifier agree with each other, the processing section stores the information requested in the setting request into the second storage section in a manner of being related to the identifier of the other tag.

4. An information display method in an information display system including: an information processing device capable of reading an identifier of a tag; and a server capable of performing communication with the information processing device through a network, wherein
the server:
stores an identifier of a first tag and an identifier of a second tag corresponding to the first tag in a manner of being related to each other;
stores information in a manner of being related to each of the identifier of the first tag and the identifier of the second tag; and
when the identifier of the first tag or the identifier of the second tag and an acquisition request for the information corresponding thereto are received from the information processing device, transmits to the information processing device the information stored in a manner of being related to the received identifier and, when the identifier of one tag selected from the identifier of the first tag and the identifier of the second tag as well as a setting request for the information corresponding to the other tag are received from the information processing device, stores the information requested in the setting request, in a manner of being related to the identifier of the other tag, and wherein
when the information has been transmitted from the server, the information processing device displays contents of the information.

5. A server capable of performing communication, through a network, with an information processing device capable of reading an identifier of a tag, comprising:
a first storage section for storing an identifier of a first tag and an identifier of a second tag corresponding to the first tag, in a manner of being related to each other;
a second storage section for storing information in a manner of being related to each of the identifier of the first tag and the identifier of the second tag; and
a processing section for, when the identifier of the first tag or the identifier of the second tag and an acquisition request for the information corresponding thereto are received from the information processing device, transmitting, to the information processing device, the information stored in the second storage section in a manner of being related to the received identifier and, when the identifier of one tag selected from the identifier of the first tag and the identifier of the second tag as well as a setting request for the information corresponding to the other tag are received from the information processing device, storing the information requested in the setting request into the second storage section in a manner of being related to the identifier of the other tag.

6. A control method for a server capable of performing communication, through a network, with an information processing device capable of reading a tag, comprising:
storing an identifier of a first tag and an identifier of a second tag corresponding to the first tag in a manner of being related to each other;
storing information in a manner of being related to each of the identifier of the first tag and the identifier of the second tag; and
when the identifier of the first tag or the identifier of the second tag and an acquisition request for the information corresponding thereto are received from the information processing device, transmitting to the information processing device the information stored in a manner of being related to the received identifier and, when the identifier of one tag selected from the identifier of the first tag and the identifier of the second tag as well as a setting request for the information corresponding to the other tag are received from the information processing device, storing the information requested in the setting request, in a manner of being related to the identifier of the other tag.

7. A program causing a computer to execute:
the processing of storing an identifier of a first tag and an identifier of a second tag corresponding to the first tag, in a manner of being related to each other;
the processing of storing information in a manner of being related to each of the identifier of the first tag and the identifier of the second tag; and
the processing of, when the identifier of the first tag or the identifier of the second tag and an acquisition request for the information corresponding thereto are received from an information processing device capable of reading a tag, transmitting to the information processing device the information stored in a manner of being related to the received identifier and, when the identifier of one tag selected from the identifier of the first tag and the identifier of the second tag as well as a setting request for the information corresponding to the other tag are received from the information processing device, storing the information requested in the setting request, in a manner of being related to the identifier of the other tag.
